(19) United States
(12) Patent Application Publication
(10) Pub. No.: US 2020/0068918 A1
(43) Pub. Date: Mar. 5, 2020

(54) CONFECTIONERY ITEM

(71) Applicant: Mark Rocha, San Marcos, TX (US)

(72) Inventor: Mark Rocha, San Marcos, TX (US)

(21) Appl. No.: 16/560,757

(22) Filed: Sep. 4, 2019

Related U.S. Application Data
(60) Provisional application No. 62/727,108, filed on Sep. 5, 2018.

(51) Int. Cl. A23G 9/48; A23G 9/42; A23P 20/25

(52) U.S. Cl. CPC A23G 9/48; A23V 2002/00; A23P 20/25; A23G 9/42

(57) ABSTRACT

Products and associated methods relate to a confectionery item having a boundary layer configured to prevent spun sugar of the confectionery item from breaking down. In an illustrative example, a confectionery item may include a frozen food core, a boundary layer configured to wrap the frozen food core, and a spun sugar layer configured to surround the boundary layer. In some embodiments, the boundary layer may be pliable at room temperature and hard at freezing temperatures. By adding the boundary layer, the frozen food core may, in some embodiments, not dissolve (e.g., “burn” or “eat” through) the spun sugar.

### CROSS-REFERENCE TO RELATED APPLICATIONS

This application also claims the benefit of U.S. Provisional Application Ser. No. 62/727,108, titled “Confectionery Item,” filed by Mark Rocha, on Sep. 5, 2018.

This application incorporates the entire contents of the foregoing application(s) herein by reference.

### TECHNICAL FIELD

Various embodiments relate generally to confectionery items.

### BACKGROUND

Ice cream is a sweetened frozen food typically eaten as a snack or dessert. It may be made from dairy milk or cream and is flavored with a sweetener, either sugar or an alternative, and any spice, such as cocoa or vanilla. Colorings are usually added, in addition to stabilizers. The mixture is stirred to incorporate air spaces and cooled below the freezing point of water to prevent detectable ice crystals from forming. The result is a smooth, semi-solid foam that is solid at very low temperatures. Ice cream becomes more malleable as its temperature increases. Vegan ice cream-substitutes can be made using soy, cashew, coconut, or almond milk.

### SUMMARY

Products and associated methods relate to a confectionery item having a boundary layer configured to prevent spun sugar of the confectionery item from breaking down. In an illustrative example, a confectionery item may include a frozen food core, a boundary layer configured to wrap the frozen food core, and a spun sugar layer configured to surround the boundary layer. In some embodiments, the boundary layer may be pliable at room temperature and hard at freezing temperatures. By adding the boundary layer, the frozen food core may, in some embodiments, not dissolve (e.g., “burn” or “eat” through) the spun sugar.

Various embodiments may achieve one or more advantages. For example, some embodiments may use different flavors of frozen food core and boundary layer to provide customers with rich tasting experiences. Some embodiments may provide a handheld confectionery item enables customers to enjoy the confectionery item while walking. Some embodiments may provide a Miller crepe style confectionery items with rich taste with multiple frozen food layers and multiple boundary layers.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a cross-sectional view of an exemplary confectionery item.

FIGS. 2A and 2B depict perspective views illustrating an exemplary process steps for making the confectionery item.

FIG. 3 depicts promotional material illustrating exemplary confectionery items.

FIG. 4 depicts a flowchart illustrating an exemplary method of making the confectionery item.

FIG. 5 depicts a cross-sectional view of another exemplary confectionery item.

Like reference symbols in the various drawings indicate like elements.

### DETAILED DESCRIPTION OF ILLUSTRATIVE EMBODIMENTS

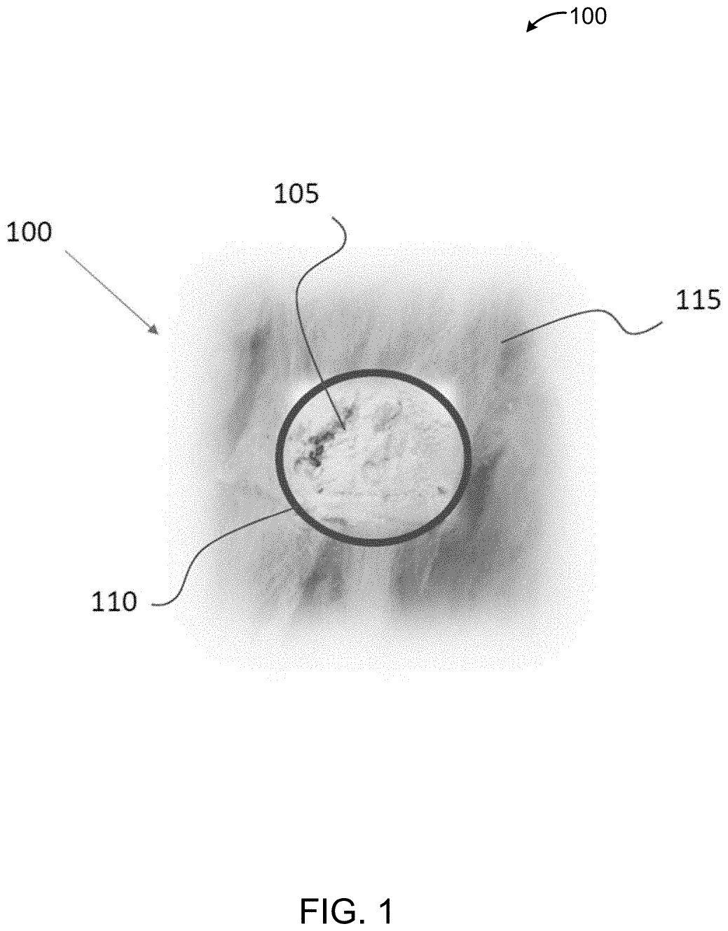

FIG. 1 depicts a cross-sectional view of an exemplary confectionery item. A confectionery item 100 includes a frozen food core 105. In some embodiments, the frozen food that makes up the core 105 may be ice cream or frozen yogurt, for example. Enclosing the core 105 is a boundary layer 110. In some examples, the boundary layer 110 be a thin, pectin-based fruit-flavored snack, such as a Fruit Roll-Up® produced by General Mills®. In various examples, the layer 110 may be a thin, sugar-based substance that is pliable at room temperature and hard at freezing temperatures. In various embodiments, the layer 110 may include multiple thin, sugar-based layers. Surrounding the layer 110 is an outer covering of spun sugar 115. In various examples, the spun sugar 115 may be cotton candy, which may be machine spun.

The layer 110 may solve a problem identified by the inventor that in the absence of the layer 110 (e.g., where core 105 and spun sugar 115 are in physical contact), the core 105 would dissolve (“burn” or “eat” through) the spun sugar 115. By adding the layer 110, a boundary is formed between the core 105 and the spun sugar 115, thus preventing the spun sugar 115 from breaking down. Accordingly, the addition of the layer 110 may solve the problem for how to prevent the ice cream 105 from breaking down the cotton candy 115. In various examples, the layer 110 may be referred to as an “intermediate layer,” while the spun sugar layer 115 may be referred to as an “outer layer.”

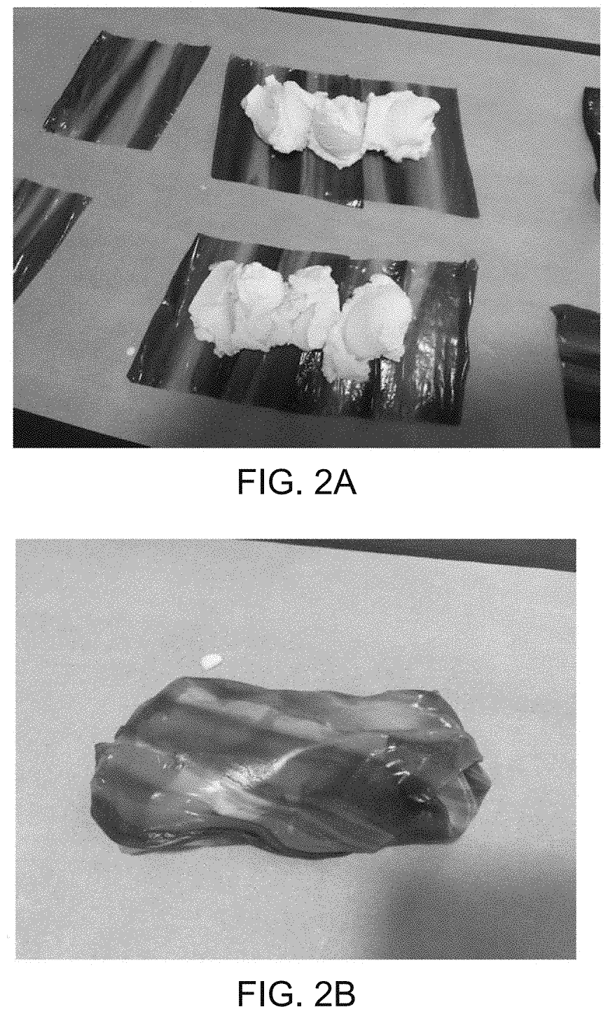

FIGS. 2A and 2B depict perspective views illustrating an exemplary process steps for making the confectionery item. At least one fruit rollup is laid down on a surface such as a table (FIG. 2A). Next, at least one portion of ice cream is placed centrally on top of the at least one fruit rollup (FIG. 2B). Next, the at least one fruit rollup is molded around the at least one portion of ice cream to completely surround the ice cream in fruit roll up (FIG. 2B). At this stage, additional fruit rollups may be used to completely surround the ice cream and provide for a thicker boundary layer. Next, the ice cream encased in fruit roll up is then covered with an outer covering of cotton candy (not shown).

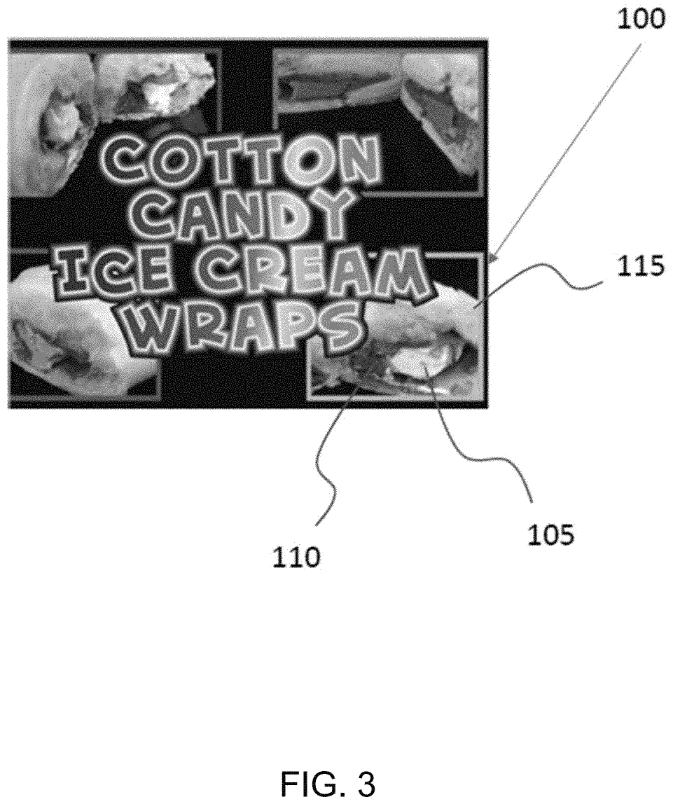

FIG. 3 depicts promotional material illustrating exemplary confectionery items. A confectionery item 100 is shown with a core 105 made of ice cream, an intermediate layer 110 made of fruit rollup, and an outer covering of cotton candy 115. The intermediate layer 110 may advantageously act as a buffering layer to prevent the ice cream core 105 from breaking down the cotton candy cover 115.

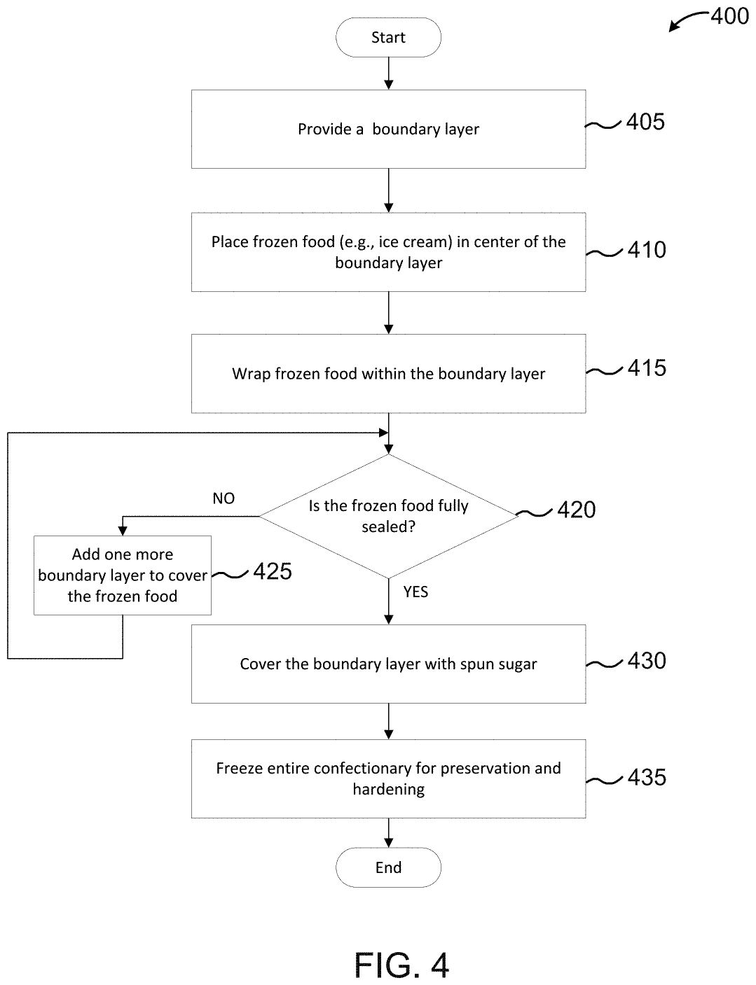

FIG. 4 depicts a flowchart illustrating an exemplary method of making the confectionery item. A manufacturing process 400 starts with providing a boundary layer (e.g., laying down a boundary layer on a surface) at 405, where the boundary layer may be a thin, sugar-based substance like a fruit rollup, for example. Next, at, 410, frozen food (e.g., ice cream) is placed near the center of the (laid-down) boundary layer. At 415, the frozen food is wrapped in the boundary layer.

Then, whether the frozen food core is fully sealed by the boundary layer is decided. If the frozen food core is not fully sealed, additional boundary layers may be added to fully enclose and seal the frozen food and provide a sufficiently thick buffer until the frozen food is fully sealed. If yes, then, the method 400 includes, at 430, the frozen food enclosed in boundary layer(s) is covered with spun sugar, which may be cotton candy, for example. At this stage, it may be said that the entire confectionery resembles an “ice cream burrito.” Next, at 435, the entire confectionery (ice cream core, fruit rollup intermediate layer, and cotton candy outer covering) is frozen for preservation and to harden the confectionery. Freezing the confectionery may allow the confectionery to be easily sliced and cut into pieces for individual serving to a customer. When the confectionery is cut, it may exhibit a “smoking” effect (like freeze dried ice cream).

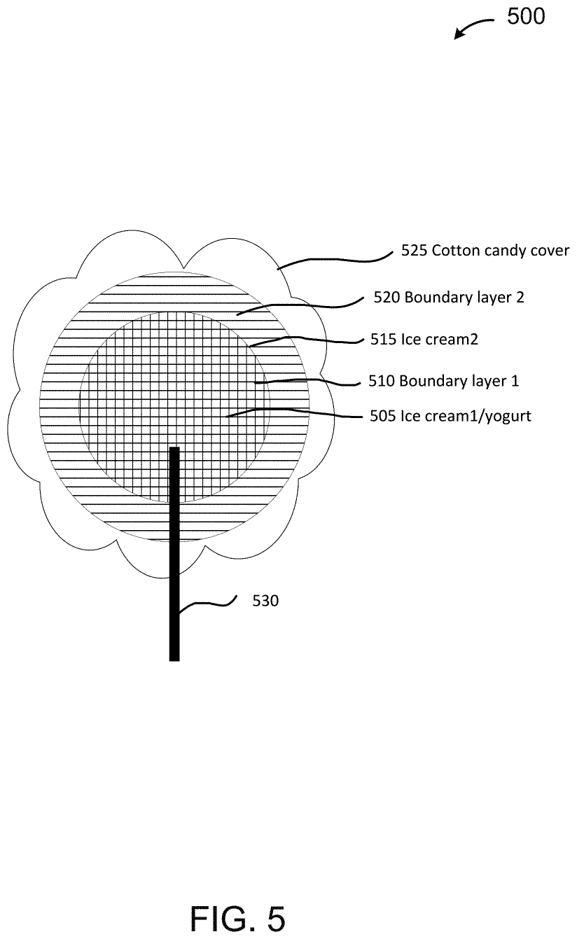

FIG. 5 depicts a cross-sectional view of another exemplary confectionery item. A confectionery item 500 includes a first frozen food core 505. In some embodiments, the frozen food that makes up the core 505 may be ice cream or frozen yogurt, for example. Enclosing the core 505 is a first boundary layer 510. In some examples, the boundary layer 510 be a thin, pectin-based fruit-flavored snack, such as a Fruit Roll-Up® produced by General Mills®. In various examples, the first boundary layer 510 may be a thin, sugar-based substance that is pliable at room temperature and hard at freezing temperatures. In various embodiments, the first boundary layer 510 may include multiple thin, sugar-based layers.

The confectionery item 500 also includes a second frozen food core 515. In some embodiments, the frozen food that makes up the core 515 may be ice cream or frozen yogurt, for example. Enclosing the core 515 is a second boundary layer 520. In some examples, the boundary layer 520 be a thin, pectin-based fruit-flavored snack, such as a Fruit Roll-Up® produced by General Mills®. In various examples, the first boundary layer 520 may be a thin, sugar-based substance that is pliable at room temperature and hard at freezing temperatures. In various embodiments, the first boundary layer 520 may include multiple thin, sugar-based layers. In some embodiments, the first frozen food core 505 and the second frozen food core 515 may be the same product (e.g., both are vanilla flavored ice creams), In some embodiments, the first frozen food core 505 and the second frozen food core 515 may be different products (e.g., one is vanilla flavored ice cream and the other one is chocolate flavored ice cream). Thus, people may taste multiple flavors with one bite. In some embodiments, the second frozen food core 515 may be replaced by other confectionery food, rather than frozen food. Surrounding the second boundary layer 520 is an outer covering of spun sugar 525. In various examples, the spun sugar 525 may be cotton candy, which may be machine spun. In some embodiments, the confectionery item 500 may include more frozen food cores and covered by corresponding boundary layers to form a Mille crepe confectionery item. In some embodiments, the confectionery item 500 may also include a supporting item 530 (e.g., a wooden stick, a chocolate stick, Wafer stick), therefore, people can handhold the confectionery item 500. Other shapes (e.g., conical) of the confectionery item 500 may also be made.

The layers 510, 520 may solve a problem identified by the inventor that in the absence of the layers 510, 520 (e.g., where core 515 and spun sugar 525 are in physical contact), the core 515 would dissolve (“burn” or “eat” through) the spun sugar 525. By adding the layers 510, 520, boundaries are formed between the core (e.g., 505, 515) and the spun sugar 525, thus preventing the spun sugar 525 from breaking down. Accordingly, the addition of the layers 510, 520 may solve the problem for how to prevent the ice cream 505, 515 from breaking down the cotton candy 525. In various examples, the layers 510, 520 may be referred to as “intermediate layers,” while the spun sugar layer 525 may be referred to as an “outer layer.”

Although various embodiments have been described with reference to the figures, other embodiments are possible. For example, other materials may be added on the cotton layer. In some embodiments, chocolate beans may be added in the frozen core.

In an exemplary aspect, a confectionery item includes a frozen food core that comprises ice cream, a boundary layer configured to wrap the frozen food core, and a spun sugar layer configured to surround the boundary layer, the boundary layer is pliable at room temperature and hard at freezing temperatures.

In some embodiments, the boundary layer may be a thin and sugar-based substance. In some embodiments, the boundary layer may be a fruit-flavored snack. In some embodiments, the boundary layer may be a fruit roll-up. In some embodiments, the spun sugar layer may be cotton candy. In some embodiments, the spun sugar layer may be machine-spun cotton candy.

In another exemplary aspect, a confectionery item includes a first frozen food core, a first boundary layer configured to wrap the first frozen food core, and a spun sugar layer configured to surround the first boundary layer, the boundary layer is pliable at room temperature and hard at freezing temperatures.

In some embodiments, the frozen food core may be ice cream. In some embodiments, the frozen food core may be frozen yogurt. In some embodiments, the boundary layer may be a thin and sugar-based substance. In some embodiments, the boundary layer may be a fruit-flavored snack. In some embodiments, the spun sugar layer may be machine-spun cotton candy. In some embodiments, the confectionery item may also include a second frozen food core and a second boundary layer configured to wrap the second frozen food core. The first frozen food core may be placed between the second boundary layer and the first boundary layer. In some embodiments, the second frozen food core may be a different product from the first frozen food core. In some embodiments, the confectionery item may be a handheld confectionery item.

In another exemplary aspect, a method of making a confectionery item includes providing a boundary layer, placing frozen food in the boundary layer, wrapping the frozen food within the boundary layer, and covering the boundary layer with spun sugar, the boundary layer is pliable at room temperature and hard at freezing temperatures.

In some embodiments, the boundary layer may be a thin and sugar-based substance. In some embodiments, the boundary layer may be a fruit-flavored snack. In some embodiments, the boundary layer may be a Fruit roll-up. In some embodiments, the spun sugar layer may be machine-spun cotton candy.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. A confectionery item comprising:
a frozen food core that comprises ice cream;
a boundary layer configured to wrap the frozen food core; and,
a spun sugar layer configured to surround the boundary layer,
wherein the boundary layer is pliable at room temperature and hard at freezing temperatures.

2. The confectionery item of claim 1, wherein the boundary layer comprises a thin and sugar-based substance.

3. The confectionery item of claim 1, wherein the boundary layer comprises a fruit-flavored snack.

4. The confectionery item of claim 1, wherein the boundary layer comprises a fruit roll-up.

5. The confectionery item of claim 1, wherein the spun sugar layer comprises cotton candy.

6. The confectionery item of claim 1, wherein the spun sugar layer comprises machine-spun cotton candy.

7. A confectionery item comprising:
a first frozen food core;
a first boundary layer configured to wrap the first frozen food core; and,
a spun sugar layer configured to surround the first boundary layer,
wherein the boundary layer is pliable at room temperature and hard at freezing temperatures.

8. The confectionery item of claim 7, wherein the frozen food core comprises frozen yogurt.

9. The confectionery item of claim 7, wherein the boundary layer comprises a thin and sugar-based substance.

10. The confectionery item of claim 7, wherein the boundary layer comprises a fruit-flavored snack.

11. The confectionery item of claim 7, wherein the spun sugar layer comprises machine-spun cotton candy.

12. The confectionery item of claim 7, further comprising:
a second frozen food core; and,
a second boundary layer configured to wrap the second frozen food core,
wherein, the first frozen food core is placed between the second boundary layer and the first boundary layer.

13. The confectionery item of claim 12, wherein the second frozen food core comprises a different product from the first frozen food core.

14. The confectionery item of claim 12, wherein the second frozen food core and the first frozen food core comprise ice cream.

15. The confectionery item of claim 13, wherein the confectionery item is a handheld confectionery item.

16. A method of making a confectionery item, comprising:
providing a boundary layer;
placing frozen food in the boundary layer;
wrapping the frozen food within the boundary layer; and,
covering the boundary layer with spun sugar,
wherein, the boundary layer is pliable at room temperature and hard at freezing temperatures.

17. The method of claim 16, wherein the boundary layer comprises a thin and sugar-based substance.

18. The method of claim 16, wherein the boundary layer comprises a fruit-flavored snack.

19. The method of claim 16, wherein the boundary layer comprises a fruit roll-up.

20. The method of claim 16, wherein the spun sugar layer comprises machine-spun cotton candy.
